(19) United States
(12) Patent Application Publication
(10) Pub. No.: US 2016/0100456 A1
(43) Pub. Date: Apr. 7, 2016

(54) Hand-held Multi-Function Heating Device

(71) Applicant: Pro-Iroda Industries, Inc., Taichung City (TW)

(72) Inventor: Jung-Fa Tsai, Taichung City (TW)

(21) Appl. No.: 14/709,681

(22) Filed: May 12, 2015

(30) Foreign Application Priority Data
Oct. 3, 2014 (TW) 103134544
Nov. 25, 2014 (TW) 103140797

(51) Int. Cl. H05B 3/00; H05B 3/03; H05B 3/46; H05B 3/06

(52) U.S. Cl. CPC H05B 3/0014; H05B 3/06; H05B 3/03; H05B 3/46

(57) ABSTRACT

A hand-held multi-function heating device includes a body receiving a power connection member and a battery. A power connector is mounted to the power connection member and includes first and second electrodes electrically connected to first and second electrodes of the power connection member respectively. An insulating tube is mounted on an end of the power connector. The insulating tube includes a first end and a second end. The second end of the insulating tube extends away from the power connection member. A first end of a heating coil is electrically connected to the first electrode of the power connector. The heating coil extends through the insulating tube and has a second end located outside of the insulating tube. The heating coil includes a coiled portion forming a heating section. The second end of the heating coil is electrically connected to the second electrode of the power connector.

### BACKGROUND OF THE INVENTION

The present invention relates to a heating device and, more particularly, to a hand-held multi-function heating device.

Smokers generally use electric cigarette lighters in automobiles and use lighters in other places. In use of a lighter using gas as the fuel, a user has to carefully control the flame, because the cigarette cannot be lit if the flame is too small, whereas a large flame is hazardous. The situation is more obvious while lighting a cigar.

Furthermore, the lighter must be stored in a cool place for safety purposes. In a case that the lighter is placed in a high temperature environment, such as in an automobile exposed to the sun, dangerous self-flaming of the lighter could occur. Furthermore, lighters have limited functions.

Thus, a need exists for a hand-held multi-function heating device to mitigate and/or obviate the above drawbacks.

### BRIEF SUMMARY OF THE INVENTION

A hand-held multi-function heating device according to the present invention includes a body having a receiving end and a gripping end. The body includes a receiving space and a chamber intercommunicated with the receiving space. The receiving space is located in the receiving end of the body. The chamber is located in the gripping end and is adapted to receive a battery. A power connection member is mounted in the receiving space and includes a first electrode and a second electrode. A heating device includes a power connector. The power connector includes a first electrode and a second electrode. When the power connector is mounted to the power connection member, the first electrode of the power connector is electrically connected to the first electrode of the power connection member, and the second electrode of the power connector is electrically connected to the second electrode of the power connection member. The heating device further includes an insulating tube and a heating coil. The insulating tube is mounted on an end of the power connector distant to the power connection member. The insulating tube includes a first end and a second end. The second end of the insulating tube extends away from the power connection member. The heating coil includes a first end and a second end. The first end of the heating coil is electrically connected to the first electrode of the power connector. The heating coil extends through the insulating tube, with the second end of the heating coil extending out of the insulating tube via the second end of the insulating tube. The heating coil includes a heating section formed by a coiled portion of the heating coil. The heating section is located on a side of the second end of the heating coil opposite to the first end of the heating coil. The second end of the heating coil is electrically connected to the second electrode of the power connector.

The heating device can further include a receiving seat mounted to the end of the power connector distant to the power connection member. The receiving seat includes a through-hole having a neck portion. The neck portion is located on an end of the through-hole adjacent to the power connection member. A width of the neck portion is smaller than a width of another end of the through-hole distant to the power connection member. The first end of the insulating tube is received in the through-hole of the receiving seat and abuts the neck portion.

The receiving seat is made of an electrically conductive material, and the insulating tube is made of an electrically insulating material. The heating device can further include a jacket made of an electrically conductive material. The jacket is mounted to the end of the power connector distant to the power connection member and is mounted around the insulating tube. The jacket includes a first end and a second end. The first end of the jacket is received in the through-hole of the receiving seat and abuts the neck portion. The second end of the jacket extends away from the power connector and contacts with the second end of the heating coil. The heating coil is electrically connected to the power connector via the jacket and the receiving seat.

The heating section can be wound around an outer periphery of the second end of the insulating tube.

The heating section of the heating coil is located on a side of the insulating tube opposite to the power connector. The heating device can further include a heat tube mounted on the second end of the insulating tube. The head tube is located between the first end of the heating coil and the heating section. The head tube is made of an electrically conductive material. The second end of the jacket contacts with an outer periphery of the head tube. The jacket clamps the second end of the heating coil between the head tube and the jacket.

The heating device can further include an extension tube mounted on the second end of the insulating tube. The extension tube is located between the first end of the heating coil and the heating section. The extension tube is made of an electrically insulating material. The head tube is mounted around a side of the extension tube opposite to the heating coil.

In an example, a transverse width of an end of the head tube opposite to the receiving tube is smaller than a transverse width of the other end of the head tube adjacent to the receiving tube. The other end of the head tube opposite to the heating coil is conic. The second end of the jacket is mounted around and contacts with a conic outer periphery of the head tube by deformation through pressing.

The power connection member can be hollow. The first electrode of the power connection member is located at a bottom of the power connection member, and the second electrode of the power connection member surround the first electrode of the power connection member and having an inner thread. The first electrode of the power connector is located at a bottom of the power connector. The second electrode of the power connector surrounds the first electrode of the power connector. The second electrode of the power connector has an outer thread threadedly engaged with the inner thread of the second electrode of the power connection member.

The hand-held multi-function heating device can further include a control button mounted between the receiving end and the gripping end of the body. The control button is adapted to be operated by a user to switch a circuit of the power connection member between a closed state and an open state.

The hand-held multi-function heating device can further include an indicator lamp mounted between the receiving end and the gripping end of the body. The indicator lamp is adapted to use electricity of the battery to emit light. The control button is adapted to synchronously switch the circuit of the power connection member and a circuit of the indicator lamp between the closed state and the open state.

The hand-held multi-function heating device can further include an end cap mounted to the gripping end of the body. The end cap is detachably mounted to an end of the receiving space distant to the receiving end for closing the receiving space.

In an example, the heating device further includes a sleeve. The sleeve is tubular and has a closed end. The sleeve is mounted around the insulating tube and abuts a side of the heating coil distant to the insulating tube. An end of the sleeve abuts the second end of the jacket.

In another example, the heating device further includes a sleeve. The sleeve is tubular and has two open ends. The sleeve is received in the through-hole of the receiving seat and abuts the neck portion. The sleeve is mounted around the jacket, extends away from the power connector, and covers the heating section of the heating coil.

The heating device can further include an end cap. The end cap closes one of the two open ends of the sleeve opposite to the power connector. The end cap is made of porcelain clay.

The hand-held multi-function heating device according to the present invention generates high heat at the heating section by electrical heating without any sparks to avoid danger during use.

The present invention will become clearer in light of the following detailed description of illustrative embodiments of this invention described in connection with the drawings.

### DESCRIPTION OF THE DRAWINGS

FIG. 1 is a perspective view of a hand-held multi-function heating device of a first embodiment according to the present invention.

FIG. 2 is a partial, perspective view of the hand-held multi-function heating device of FIG. 1.

FIG. 3 is a cross sectional view of the hand-held multi-function heating device of FIG. 1.

FIG. 4 an enlarged view of a portion of the hand-held multi-function heating device of FIG. 3.

FIG. 5 is a diagrammatic perspective view illustrating use of the hand-held multi-function heating device of FIG. 1.

FIG. 6 is a perspective view of a hand-held multi-function heating device of a second embodiment according to the present invention.

FIG. 7 is a partial, cross sectional view of the hand-held multi-function heating device of FIG. 6.

FIG. 8 is a perspective view of a hand-held multi-function heating device of a third embodiment according to the present invention.

FIG. 9 is a partial, exploded, perspective view of the hand-held multi-function heating device of FIG. 8.

FIG. 10 is a partial, enlarged, cross sectional view of the hand-held multi-function heating device of FIG. 8.

FIG. 11 is an enlarged view of the hand-held multi-function heating device of FIG. 10.

FIG. 12 is a partial, cross sectional view of a hand-held multi-function heating device of a fourth embodiment according to the present invention.

### DETAILED DESCRIPTION OF THE INVENTION

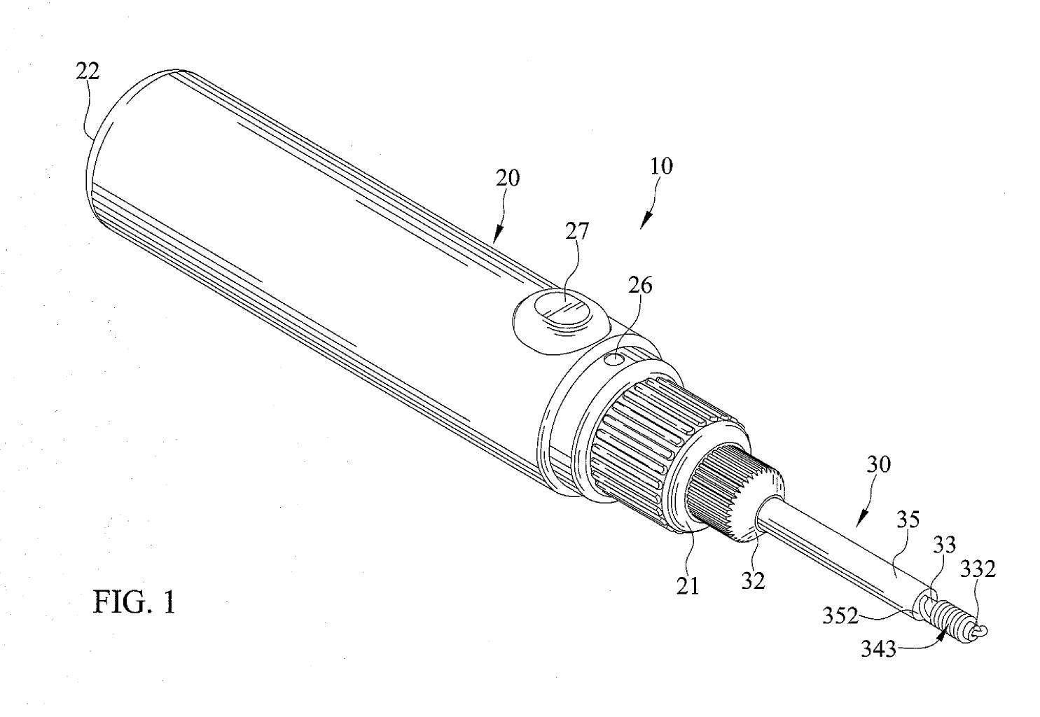

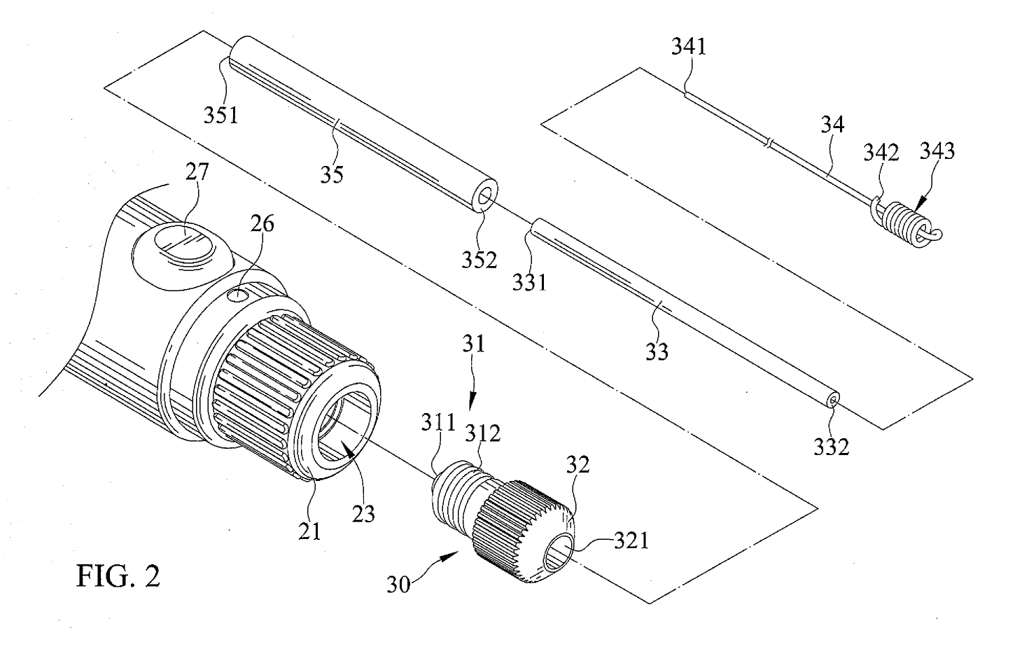

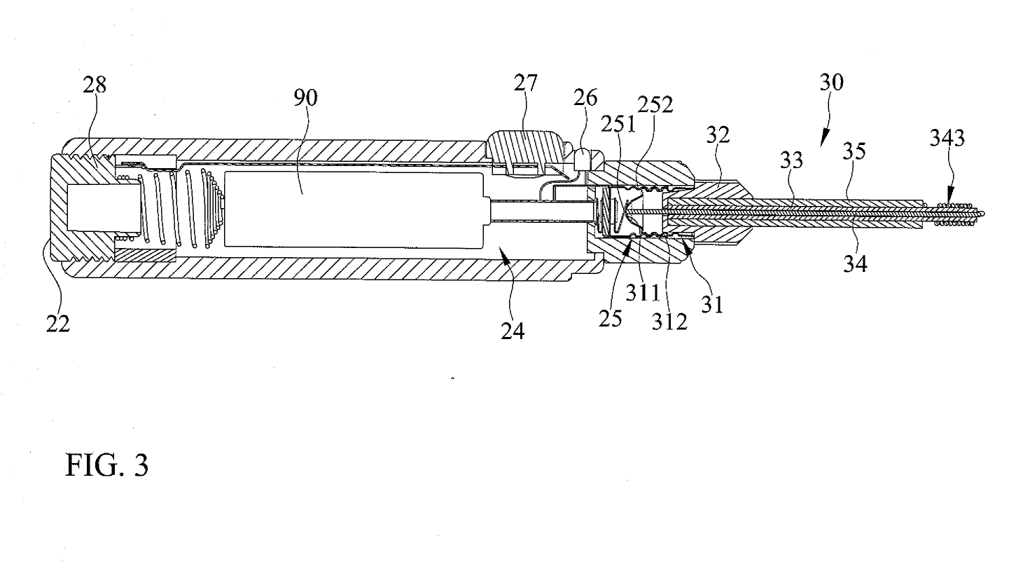

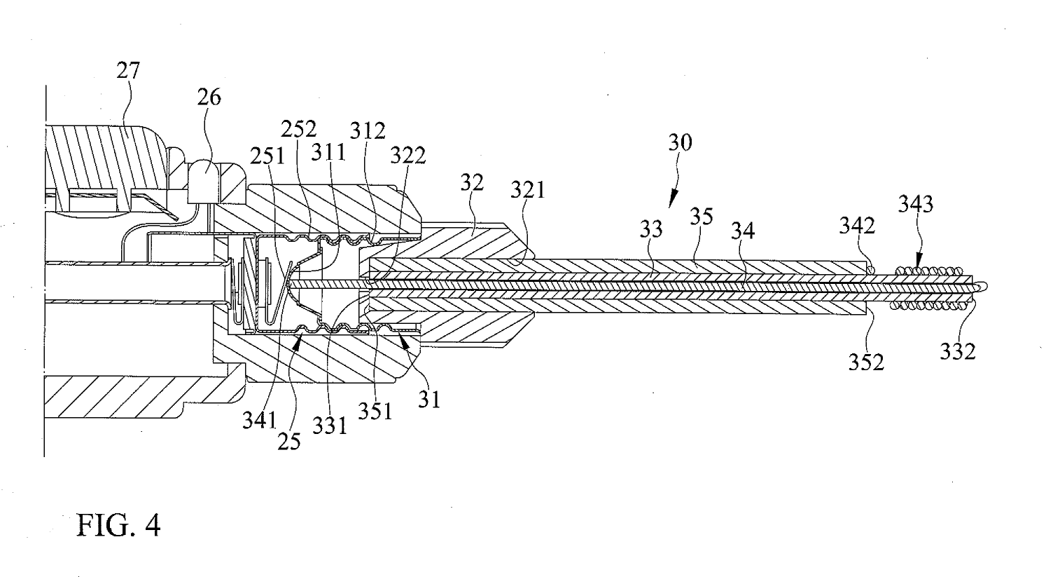

With reference to FIGS. 1-5, a hand-held multi-function heating device 10 of a first embodiment according to the present invention includes a body 20 and a heating device 30. The body 20 includes a receiving end 21 and a gripping end 22. The body 20 includes a receiving space 23 and a chamber 24 intercommunicated with the receiving space 23. The receiving space 23 is located in the receiving end 21 of the body 20. The chamber 24 is located in the gripping end 22 and is adapted to receive a battery 90.

A power connection member 25 is mounted in the receiving space 23 of the body 20. The power connection member 25 is hollow. The power connection member 25 includes a first electrode 251 and a second electrode 252. The first electrode 251 is located at a bottom of the power connection member 25. The second electrode 252 surrounds the first electrode 251 of the power connection member 25 and has an inner thread.

An indicator lamp 26 and a control button 27 are mounted between the receiving end 21 and the gripping end 22 of the body 20. The indicator lamp 26 is adapted to use electricity of the battery 90 to emit light. The control button 27 is adapted to synchronously switch a circuit of the power connection member 25 and a circuit of the indicator lamp 26 between a closed state and an open state.

An end cap 28 is mounted to the gripping end 22 of the body 20. The end cap 28 is detachably mounted to an end of the receiving space 23 distant to the receiving end 21 for closing the receiving space 23.

The heating device 30 includes a power connector 31 and a receiving seat 32. The power connector 31 includes a first electrode 311 and a second electrode 312. The first electrode 311 of the power connector 31 is located at a bottom of the power connector 31. The second electrode 312 of the power connector 31 surrounds the first electrode 311 of the power connector 31. The second electrode 312 of the power connector 31 has an outer thread threadedly engaged with the inner thread of the second electrode 252 of the power connection member 25. When the power connector 31 is mounted to the power connection member 25, the first electrode 311 of the power connector 31 is electrically connected to the first electrode 251 of the power connection member 25, and the second electrode 312 of the power connector 31 is electrically connected to the second electrode 252 of the power connection member 25.

The receiving seat 32 is mounted to the end of the power connector 31 distant to the power connection member 25. The receiving seat 32 includes a through-hole 321 having a neck portion 322. The neck portion 322 is located on an end of the through-hole 321 adjacent to the power connection member 25. A width of the neck portion 322 is smaller than a width of the other end of the through-hole 321 distant to the power connection member 25. In this embodiment, the receiving seat 32 is made of an electrically conductive material.

The heating device 30 further includes an insulating tube 33, a heating coil 34, and a jacket 35. The insulating tube 33 is mounted on an end of the power connector 31 distant to the power connection member 25. The insulating tube 33 includes a first end 331 and a second end 332. The first end 331 of the insulating tube 33 is received in the through-hole 321 of the receiving seat 32 and abuts the neck portion 322. The second end 332 of the insulating tube 33 extends away from the power connection member 25. In this embodiment, the insulating tube 33 is made of an electrically insulating material.

In this embodiment, the heating coil 34 is made of an electrically conductive material, is flexible, and is elongated. The heating coil 34 includes a first end 341 and a second end 342. The first end 341 of the heating coil 34 is electrically connected to the first electrode 311 of the power connector 31. The heating coil 34 extends through the insulating tube 33, with the second end 342 of the heating coil 34 extending out of the insulating tube 33 via the second end 332 of the insulating tube 33. The heating coil 34 further includes a heating section 343 formed by a coiled portion of the heating coil 34. The heating section 343 is located on a side of the second end 342 of the heating coil 34 opposite to the first end 341 of the heating coil 34. In this embodiment, the heating section 343 is wound around an outer periphery of the second end 332 of the insulating tube 32. The second end 342 of the heating coil 34 is electrically connected to the second electrode 312 of the power connector 31.

In this embodiment, the jacket 35 is made of an electrically conductive material. The jacket 35 is mounted to the end of the power connector 31 distant to the power connection member 25 and is mounted around the insulating tube 33. The jacket 35 includes a first end 351 and a second end 352. The first end 351 of the jacket 35 is received in the through-hole 321 of the receiving seat 32 and abuts the neck portion 322. The second end 352 of the jacket 35 extends away from the power connector 31 and contacts with the second end 342 of the heating coil 34. Thus, with the heating coil 34 is electrically connected to the power connector 31 via the jacket 35 and the receiving seat 32.

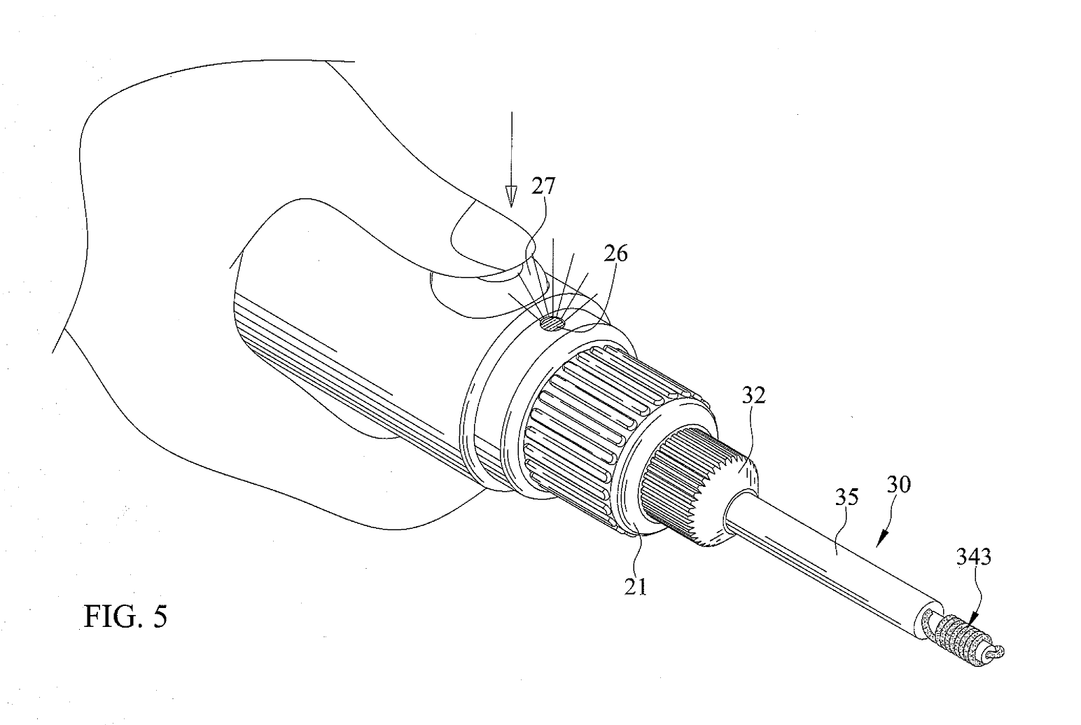

FIG. 5 shows use of the hand-held multi-function heating device 10 of the first embodiment according to the present invention. In use, the control button 27 is firstly pressed to switch the circuits of the power connection member 25 and the indicator lamp 26 into the open state. The electricity of the battery 90 is supplied through the power connection member 25 and the power connector 31 to the heating coil 34 to heat the heating coil 34. High heat is generated at the coiled portion (i.e., the heating section 343) of the heating coil 34 to permit a user to rapidly light a cigarette or a cigar. The hand-held multi-function heating device 10 generates the high heat by electrical heating without any sparks to avoid danger during use.

Furthermore, since the circuits of the power connection member 25 and the indicator lamp 26 are synchronous, the user can be aware of the high temperature state of the hand-held multi-function heating device 10 by the light emitted by the indicator lamp 26. Thus, the user can avoid touching the front end of the hand-held multi-function heating device 10 to prevent scald.

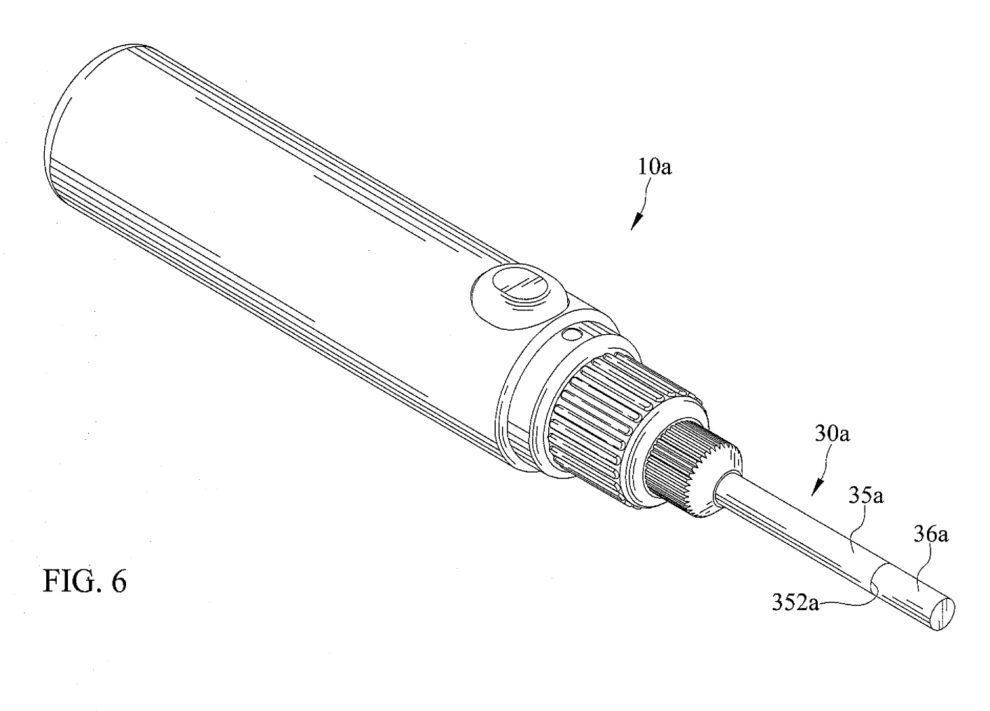

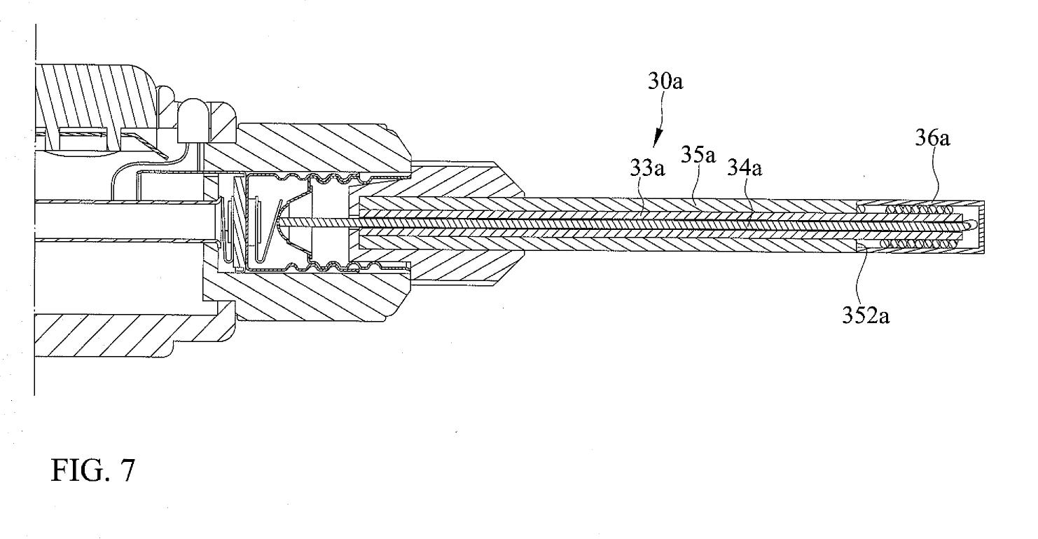

FIGS. 6 and 7 show a hand-held multi-function heating device 10a of a second embodiment according to the present invention. The second embodiment is substantially the same as the first embodiment except that the heating device 30a further includes a sleeve 36a. In this embodiment, the sleeve 36a is tubular and has a closed end. The sleeve 36a is mounted around the insulating tube 33a and abuts a side of the heating coil 34a distant to the insulating tube 33a. An end of the sleeve 36a abuts the second end 352a of the jacket 35a. In this embodiment, the sleeve 36a is made of porcelain clay.

By providing the sleeve 36a on the front end of the hand-held multi-function heating device 10a, the sleeve 36a can shield the heating coil 34a to provide an aesthetic appearance. Furthermore, the sleeve 36a made of porcelain clay permits uniform heating.

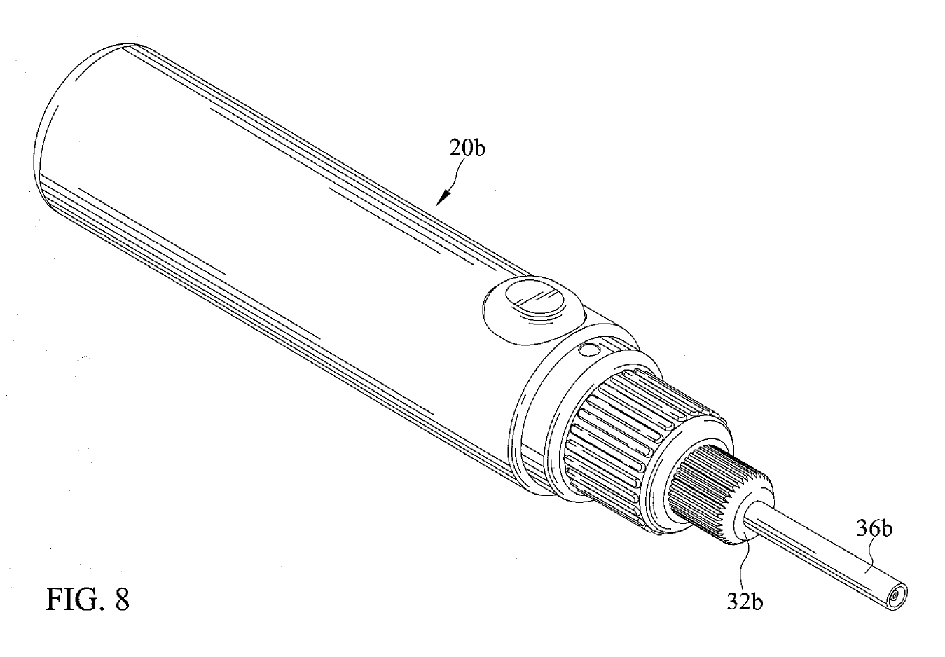

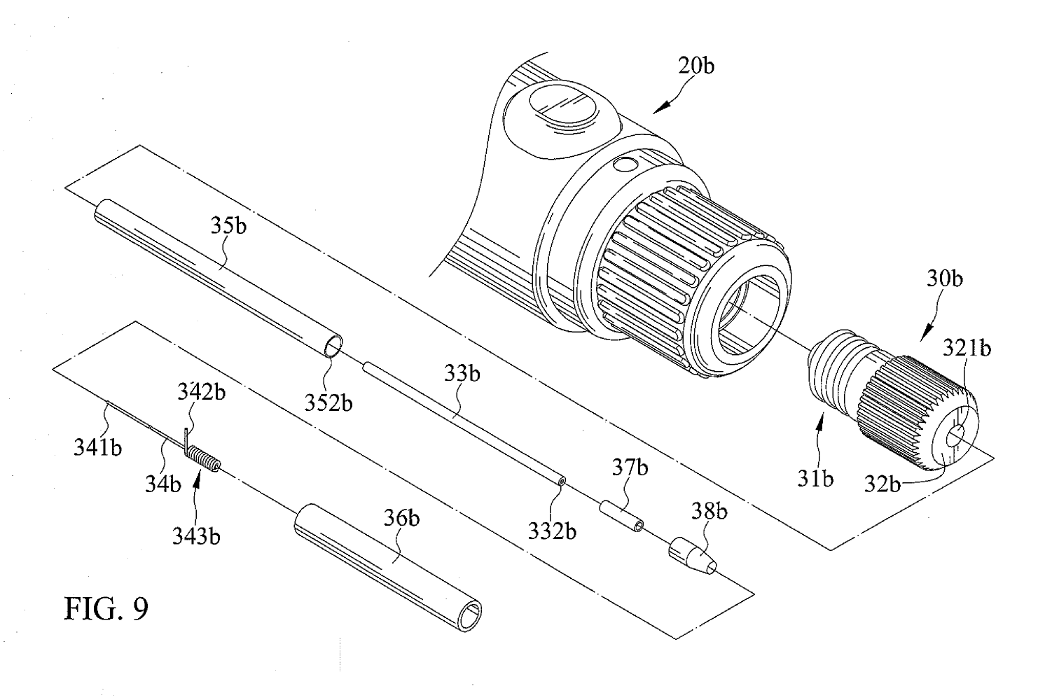

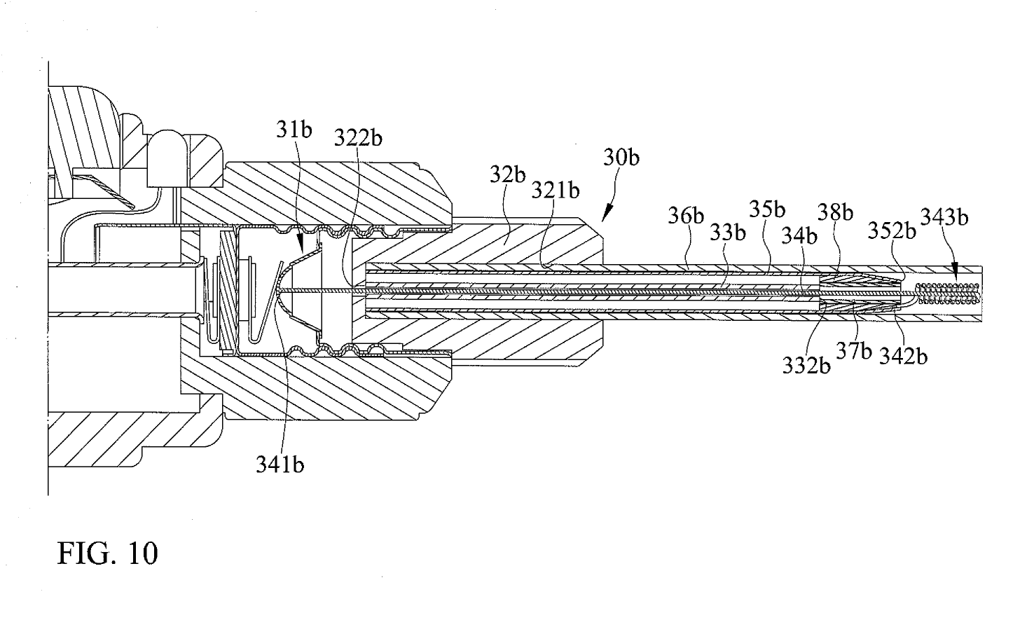

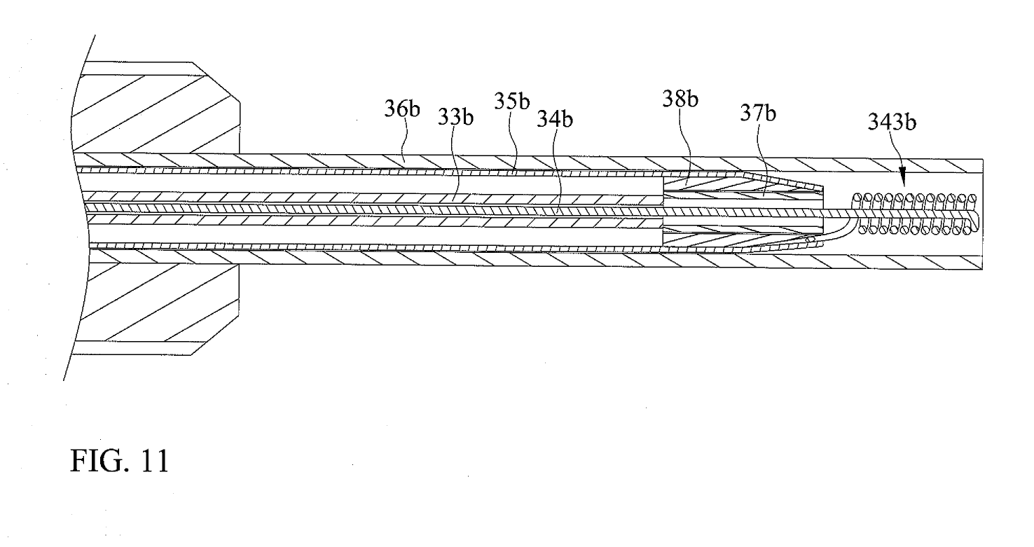

FIGS. 8-11 show a hand-held multi-function heating device 10b of a third embodiment according to the present invention. The third embodiment is substantially the same as the second embodiment except that the appearance of the body 20b can be modified according to the user needs or preference.

In this embodiment, the heating section 343b of the heating coil 34b is located on a side of the insulating tube 33b opposite to the power connector 31. The heating device 30b further includes an extension tube 37b and a head tube 38b. The extension tube 37b and the heat tube 38b are mounted on the second end 332b of the insulating tube 33b and are located between the first end 341b of the heating coil 34b and the heating section 343b. In this embodiment, the extension tube 37b is made of an electrically insulating material. The head tube 38b is mounted around a side of the extension tube 37b opposite to the heating coil 34b. A transverse width of an end of the head tube 38b opposite to the receiving tube 32b is smaller than a transverse width of the other end of the head tube 38b adjacent to the receiving tube 32b. The other end of the head tube 38b opposite to the heating coil 34b is conic. In this embodiment, the head tube 38b is made of an electrically conductive material.

The second end 352b of the jacket 35b extends away from the power connector 31b. Furthermore, the second end 352b of the jacket 35b is mounted around and contacts with a conic outer periphery of the head tube 38b by deformation through pressing. The jacket 35b clamps the second end 342b of the heating coil 34b between the head tube 38b and the jacket 35b. Thus, the heating coil 34b is electrically connected to the power connector 31b via the head tube 38b, the jacket 35b, and the receiving seat 32b.

In this embodiment, the sleeve 36b is tubular and has two open ends. The sleeve 36b is received in the through-hole 321b of the receiving seat 32b and abuts the neck portion 322b. The sleeve 36b is mounted around the jacket 35b, extends away from the power connector 31b, and covers the heating section 343b of the heating coil 34b. In this embodiment, the sleeve 36b is made of porcelain clay.

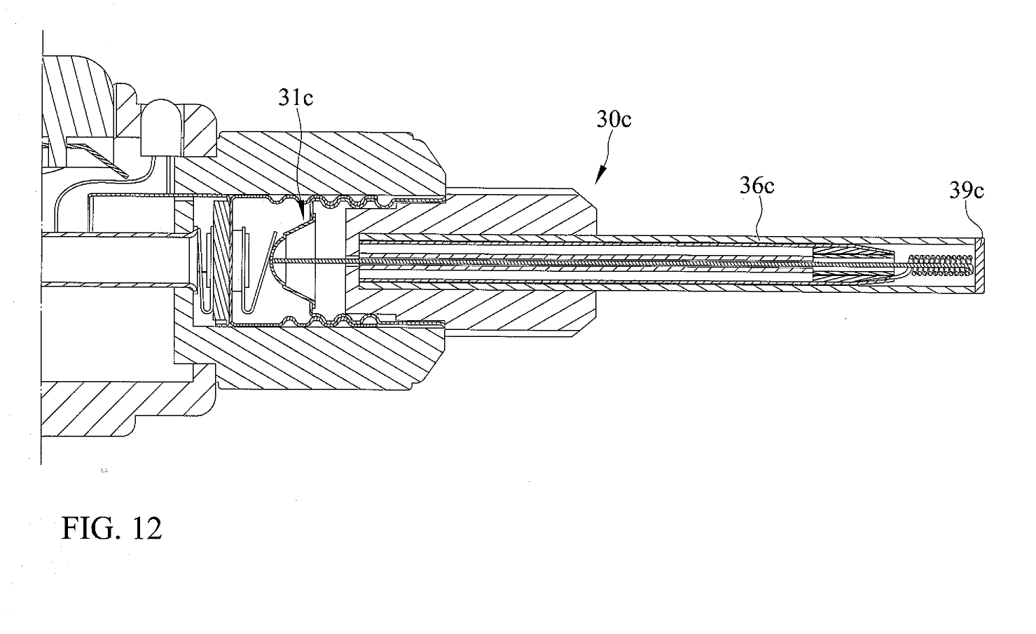

FIG. 12 shows a hand-held multi-function heating device 10c of a fourth embodiment according to the present invention. The fourth embodiment is substantially the same as the third embodiment except that the heating device 30c further includes an end cap 39c. The end cap 39c closes one of the two open ends of the sleeve 36c opposite to the power connector 31c. In this embodiment, the end cap 39c is made of porcelain clay.

In view of the foregoing, the hand-held multi-function heating device 10, 10a, 10b, 10c according to the present invention generates high heat at the heating section 343, 343a, 343b, 343c by electrical heating without any sparks to avoid danger during use. Furthermore, the hand-held multi-function heating device 10, 10a, 10b, 10c can be used to perform other functions, such as sculpture, lighting a fire in the field, etc.

Although specific embodiments have been illustrated and described, numerous modifications and variations are still possible without departing from the scope of the invention. The scope of the invention is limited by the accompanying claims.

1. A hand-held multi-function heating device comprising:
a body including a receiving end and a gripping end, with the body including a receiving space and a chamber intercommunicated with the receiving space, with the receiving space located in the receiving end of the body, with the chamber located in the gripping end and adapted to receive a battery, with a power connection member mounted in the receiving space and including a first electrode and a second electrode; and
a heating device including a power connector, with the power connector including a first electrode and a second electrode, wherein when the power connector is mounted to the power connection member, the first electrode of the power connector is electrically connected to the first electrode of the power connection member, and the second electrode of the power connector is electrically connected to the second electrode of the power connection member, with the heating device further including an insulating tube and a heating coil, with the insulating tube mounted on an end of the power connector distant to the power connection member, with the insulating tube including a first end and a second end, with the second end of the insulating tube extending away from the power connection member, with the heating coil including a first end and a second end, with the first end of the heating coil electrically connected to the first electrode of the power connector, with the heating coil extending through the insulating tube, with the second end of the heating coil extending out of the insulating tube via the second end of the insulating tube, with the heating coil including a heating section formed by a coiled portion of the heating coil, with the heating section located on a side of the second end of the heating coil opposite to the first end of the heating coil, and with the second end of the heating coil electrically connected to the second electrode of the power connector.

2. The hand-held multi-function heating device as claimed in claim 1, with the heating device further including a receiving seat mounted to the end of the power connector distant to the power connection member, with the receiving seat including a through-hole having a neck portion, with the neck portion located on an end of the through-hole adjacent to the power connection member, with a width of the neck portion smaller than a width of another end of the through-hole distant to the power connection member, and with the first end of the insulating tube received in the through-hole of the receiving seat and abutting the neck portion.

3. The hand-held multi-function heating device as claimed in claim 2, with the receiving seat made of an electrically conductive material, with the insulating tube made of an electrically insulating material, with the heating device further including a jacket made of an electrically conductive material, with the jacket mounted to the end of the power connector distant to the power connection member and mounted around the insulating tube, with the jacket including a first end and a second end, with the first end of the jacket received in the through-hole of the receiving seat and abutting the neck portion, with the second end of the jacket extending away from the power connector and contacting with the second end of the heating coil, and with the heating coil electrically connected to the power connector via the jacket and the receiving seat.

4. The hand-held multi-function heating device as claimed in claim 3, with the heating section wound around an outer periphery of the second end of the insulating tube.

5. The hand-held multi-function heating device as claimed in claim 3, with the heating section of the heating coil located on a side of the insulating tube opposite to the power connector, with the heating device further including a heat tube mounted on the second end of the insulating tube, with the head tube located between the first end of the heating coil and the heating section, with the head tube made of an electrically conductive material, with the second end of the jacket contacting with an outer periphery of the head tube, and with the jacket clamping the second end of the heating coil between the head tube and the jacket.

6. The hand-held multi-function heating device as claimed in claim 5, with the heating device further including an extension tube mounted on the second end of the insulating tube, with the extension tube located between the first end of the heating coil and the heating section, with the extension tube made of an electrically insulating material, and with the head tube mounted around a side of the extension tube opposite to the heating coil.

7. The hand-held multi-function heating device as claimed in claim 5, with a transverse width of an end of the head tube opposite to the receiving tube being smaller than a transverse width of another end of the head tube adjacent to the receiving tube, with the other end of the head tube opposite to the heating coil being conic, and with the second end of the jacket mounted around and contacting with a conic outer periphery of the head tube by deformation through pressing.

8. The hand-held multi-function heating device as claimed in claim 1, with the power connection member being hollow, with the first electrode of the power connection member located at a bottom of the power connection member, with the second electrode of the power connection member surrounding the first electrode of the power connection member and having an inner thread, with the first electrode of the power connector located at a bottom of the power connector, with the second electrode of the power connector surrounding the first electrode of the power connector, and with the second electrode of the power connector having an outer thread threadedly engaged with the inner thread of the second electrode of the power connection member.

9. The hand-held multi-function heating device as claimed in claim 8, further comprising a control button mounted between the receiving end and the gripping end of the body, with the control button adapted to be operated by a user to switch a circuit of the power connection member between a closed state and an open state.

10. The hand-held multi-function heating device as claimed in claim 9, further comprising an indicator lamp mounted between the receiving end and the gripping end of the body, with the indicator lamp adapted to use electricity of the battery to emit light, with the control button adapted to synchronously switch the circuit of the power connection member and a circuit of the indicator lamp between the closed state and the open state.

11. The hand-held multi-function heating device as claimed in claim 10, further comprising an end cap mounted to the gripping end of the body, with the end cap detachably mounted to an end of the receiving space distant to the receiving end for closing the receiving space.

12. The hand-held multi-function heating device as claimed in claim 11, with the heating device further including a sleeve, with the sleeve being tubular and having a closed end, with the sleeve mounted around the insulating tube and abutting a side of the heating coil distant to the insulating tube, and with an end of the sleeve abutting the second end of the jacket.

13. The hand-held multi-function heating device as claimed in claim 11, with the heating device further including a sleeve, with the sleeve being tubular and having two open ends, with the sleeve received in the through-hole of the receiving seat and abutting the neck portion, and with the sleeve mounted around the jacket, extending away from the power connector, and covering the heating section of the heating coil.

14. The hand-held multi-function heating device as claimed in claim 11, with the heating device further including an end cap, with the end cap closing one of the two open ends of the sleeve opposite to the power connector, and with the end cap made of porcelain clay.
